(19) United States
(12) Patent Application Publication
(10) Pub. No.: US 2015/0134444 A1
(43) Pub. Date: May 14, 2015

(54) USER-FRIENDLY ADS IN SEARCH RESULT PAGE

(71) Applicants: Lusha LIANG, Irvine, CA (US); Ping Liang, Irvine, CA (US)

(72) Inventors: Lusha LIANG, Irvine, CA (US); Ping Liang, Irvine, CA (US)

(21) Appl. No.: 14/078,493

(22) Filed: Nov. 12, 2013

(51) Int. Cl. G06Q 30/02; G06Q 50/00

(52) U.S. Cl. CPC G06Q 30/0245; G06Q 30/0257; G06Q 50/01
USPC 705/14.44; 705/14.55

(57) ABSTRACT

This invention includes a method for displaying ads in a search result page comprising displaying one or more pages with only search results without ads; and displaying one or more first tabs or links in the search results page, at one or more of the four sides of the page, whereas when a user clicks or taps on a first tab or link, ads from one or more advertisers are shown, either on one or more separate pages containing only these ads or on the same page with the search results.

This application claims the benefit of U.S. Provisional Application No. 61/725,484, filed on Nov. 13, 2012.

### FIELD OF THE INVENTION

The present application relates to methods for placing ads in search result pages.

### BACKGROUND

Prior art for monetizing search engine service displays ads on the same page with organic search results, such as the Adwords by Google, Baidu and Bing. The ads are displayed often right at the top of the search results which is annoying to users, and at the right side along the search results, and sometimes at the bottom of the search results page. Search engine service providers need to monetize their service -to be able to continue to provide the service. However, search engine has become such a lucrative business and these providers continue to try to push more ads to earn even more money, often in ways that are obtrusive and annoying to the user experience. Many users revolt by installing ad blockers in their browser to block the ads. However, sometimes, a user with an ad blocker installed may wish to see ads for some searches. In these cases, the user has to temporarily disable the ad blocker, and remember to re-enable it afterwards, which is rather inconvenient.

This invention aims to correct this problem, providing a method for a search engine providers to display ads, but in a user friendly way and gives the control of when and whether to see ads to the user. There is no prior art that provides the functions of the embodiments presented in this invention.

### BRIEF DESCRIPTION OF THE FIGURES

FIG. 1 shows two browser window examples of a search result page without ads and tabs that are linked to ads.

FIG. 2 shows two mobile device display examples of a search result page without ads and tabs that are linked to ads.

FIG. 3 shows a display of ads with a “back to search results” tab in a browser window.

FIG. 4 shows a display of ads with a “back to search results” tab in a mobile device display.

FIG. 5 shows a display of ads with rating and review information and a vote button in a browser window.

FIG. 6 shows a display of ads with rating and review information and a vote button in a mobile device display.

### DETAILED DESCRIPTION OF THE PRESENT INVENTION

Reference may now be made to the drawings wherein like numerals refer to like parts throughout. Exemplary embodiments of the invention may now be described. The exemplary embodiments are provided to illustrate aspects of the invention and should not be construed as limiting the scope of the invention. When the exemplary embodiments are described with reference to block diagrams or flowcharts, each block represents both a method step or an apparatus element for performing the method step. Depending upon the implementation, the corresponding apparatus element may be configured in hardware, software, firmware or combinations thereof.

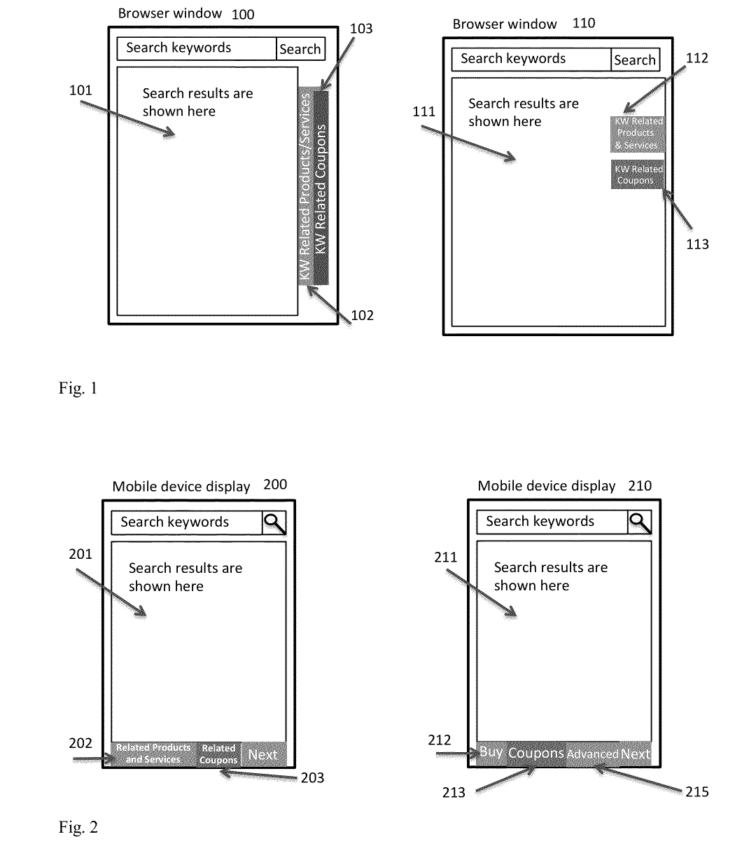

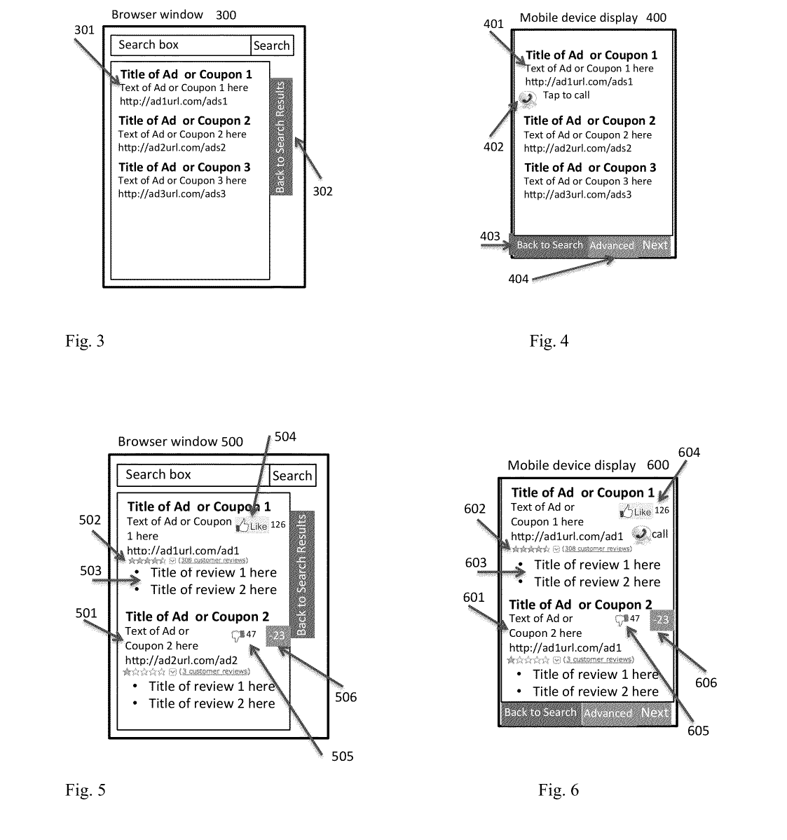

One embodiment is a method for displaying ads in a search result page, as shown in FIG. 1 for a large browser window 100 and 110 on a personal computer (hereafter referred to as a browser window) or in FIG. 2 for a mobile device display 200 or 210 (which may be a display for an app or a browser for a mobile device), comprising displaying one or more pages with only search results 101, 110, 201 or 211, i.e., no ads or promotions and the search results are included and ranked in the page based on their relevance or usefulness to the search, and displaying one or more first tabs or links in the search results page, e.g., labeled as KW Related Products and Services (or KW Related Merchants, KW Related Ads, Buy, Shopping etc., where KW=keyword(s) used to conduct the search), 102 or 112 for a browser window and 202 and 212 for a mobile device display, and/or KW Related Coupons, 103 or 113 for a browser window and 203 or 213 on a mobile device display, shown at the top or bottom or along side of the search results, whereas when a user clicks or taps on a first tab or link, ads and/or coupon/promotion, 301 for a browser window and 401 for a mobile device display, (hereafter all referred to as ads) from one or more advertisers are shown, either on one or more separate pages containing only these ads as shown in FIG. 3 for a browser or in FIG. 4 for a mobile device, or on the same page with the search results, e.g., along the side of search results. An advertiser may be a brand, a manufacturer, a seller or service provider, or someone who wishes a piece of information to be shown to a user performing a search that is related to the information in some manner.

Furthermore, the one or more first tabs or links may float on the page and remain visible as a user scrolls a search results page or turns to another search results page, thus allowing a user to quickly click or tap a first tab or link whenever he wishes. In the example of FIG. 1, the KW Related Products and Services tab 102 or 112 and/or KW Related Coupons tab 103 or 113 will scroll with the page and appear on each search results page, and always remain visible along side the search results. The first tabs can be made to standout but unobtrusive, e.g., along the top right corner or along the side or bottom edge of a search results page, shown in a easily distinguishable color from the rest of the page, as illustrated in FIGS. 1 and 2. Thus, a first tab or link is easily visible when a user wishes to find it but stays out of way of the search results and easily ignored when a user does not wish to click or tap on them. Similarly, as illustrated in FIGS. 3 and 4, on a page showing ads, an easily visible and always accessible second link or tab is provided so a user can easily click or tap the second link or tab to return to the search results page, shown as 302 for a browser window and 403 for a mobile device display. If the ads are shown on the same page with search results, an easily visible and always accessible second link or tab is provided so a user can click or tap the second link or tab to hide the ads from search results page.

A tap to call button or link 402 for an ad can be added on a mobile device that includes a phone function so that a user may easily call an advertiser by tapping this button or link. An Advanced tab 404 may also be provided on a mobile device display so that more functions and/or settings can be made accessible to a user when the tab is tapped.

Another embodiment of this invention is a method to provide information about an ad comprising displaying near or along side of an ad information about the ad to assist a user to evaluate or make a decision about the content of an ad or the reliability or credibility of the ad or the advertiser of the ad. Such information may be provided by reviewers or obtained by using a search engine to search the Internet for information about the product, service or content of the ad, and/or about the advertiser of the ad, which may include customer reviews or reviews by professional reviewers or editors 503 and 603, number of “Likes” 504, 505, 604 and 605 or average stars and number of ratings 502 and 602 or other forms of votes or ratings expressed by people using a rating or voting button such as Facebook Like or Google +1, opinions expressed by people in blogs, online forums, social networks such as Facebook, and micro blogs such as Twitter or Weibo, etc, as illustrated in FIG. 5 for a browser window or in FIG. 6 for a mobile device display. Another embodiment displays a vote or rating button or link 506 and 606 near or next to an ad 501 and 601 and can accept a positive or negative vote or a star rating, e.g., 1 to 5 stars, on the ad from a user, as illustrated in FIG. 5 for a browser window or in FIG. 6 for a mobile device display. The method may be configured to accept vote or rating from a user only after the user has clicked/tapped and visited the page linked by the ad. Furthermore, it may display an input box and accept comments or reviews on the ad from a user.

Requiring a user to return to the page that lists the ad and its link can be an inconvenience. Another embodiment uses an extension/plug-in to add a vote or rating icon in a browser's toolbar or an app's setting, clicking or tapping which will accept a vote or rating from the user on the page or website that is linked by the ad and is currently being viewed by the user. It may also allow a user to enter comments or reviews on the page or website that is linked by the ad and is currently being viewed by the user. The extension/plug-in of the vote or rating icon may be provided for download and installation by a user, or included or pre- installed as part of the browser software or app which will be installed when the browser or app is installed, setup or updated.

Furthermore, to ensure objectivity and credibility of the information and vote/rating about an ad, it is important that the information about an ad and/or the vote/rating or user comments/reviews on an ad are provided independent from the advertiser, i.e., to make it infeasible or difficult for the advertiser to control on and/or manipulate the information and/or vote/rating or user comments/reviews, or filter out all or most of the effects of such control or manipulation. One embodiment analyzes the relations of sources of the information with the advertiser of an ad using available information including databases, accumulated past knowledge, and what can be gathered over the Internet about the advertiser and the sources, e.g., owners of domain names, business relations (cooperative or competitive) among them, common business partners, any third party or multiple parties that can connect them, web links among them including links through multiple intermediaries, common officers or employees, etc. It is often necessary to analyze non-direct relations via multiple intermediary connections. Data mining techniques can be applied for these purposes. Another embodiment uses techniques to prevent manipulation of the vote/rating or comments/reviews by users, including Captcha and analysis the IP patterns of the users entering the vote/rating or comments/reviews, similar to click fraud detection, and/or requiring a user to log in using an account before he can vote/rate or comment/review an ad. Requiring log in using an account that requires a true identity or, preferably of an e-commerce or online payment website which requires a payment method such as a credit card, or online banking account, offers greater assurance that a user is a real person. Even so, analysis of the voting/rating or commenting/reviewing patterns of users is still needed to prevent users “helping” to rate higher each others' ads, or detecting sophisticated “rating” exchanges, or maliciously voting down the ads of competitors. It may also require a user to have actually used or purchased the product or service in the ad before the user can rate/comment on the ad, or alternatively, reviews from users who have actually used or purchased the product or service in the ad are given more weight or higher ranking.

The above embodiments for providing information on an ad and/or accepting feedback on an ad from users are applicable to ads in prior art search engines, display ads in browsers or apps, ads in online games or mobile apps, as well as to the embodiments of this invention which only displays ads when a user specifically indicate a desire to see the ads. These embodiments fundamentally change the nature of ads served by a search engine or ads displayed in an browser or an app; an ad is no longer displayed as a simple ad, but an aggregation of an advertiser's promotion and useful third-party information about the product, service or advertiser of the ads so that a user can evaluate the ad and make a smart decision on the credibility and value provided by the ad.

Prior art search engines or display ad servers rank ads based on how much an advertiser is willing to pay and/or how much money that ad can earn for the search engine provider or display ads server. As a result, the ranking may not best serve the interest of the users. One extension of the above embodiments for providing information on an ad and/or accepting feedback on an ad from users includes the nature (e.g., positive or negative) of the information about the ad, the product, service or advertiser of the ad, and/or the votes/ratings and/or comments/reviews from users on the ad as a parameter in deciding the rank of the ad, such that relevant ads with more positive information and/or higher positive votes/ratings and/or more positive comments/reviews are given a higher rank in the display or are displayed more often.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

What is claimed is:

1. A method for displaying ads in a search result page comprising
Displaying one or more pages with only search results without ads; and,
Displaying one or more first tabs or links in the search results page, at one or more of the four sides of the page, whereas when a user clicks or taps on a first tab or link, ads from one or more advertisers are shown, either on one or more separate pages containing only these ads or on the same page with the search results; and,
Displaying a return tab or hide ads tab when ads are shown and when a user clicks or taps the return tab or hide ads tab, the display returns to the search results page from the ads page or hides the ads in the search results page.

2. The method in claim 2 further comprising the one or more first tabs or links float on the page and remain visible as a user scrolls a search results page or turns to another search results page to allow a user to quickly click or tap a first tab or link whenever he wishes.

3. A method for providing information about an ad comprising displaying with an ad first information about the ad to assist a user in evaluating or making a decision about the content of an ad or the reliability or credibility of the ad or the advertiser, whereas such first information may be provided by users, reviewers or obtained by using a search engine to search, aggregate and analyze second information on the Internet about the product, service or the content described in the ad, and/or about the advertiser, whereas the second information may include customer reviews, reviews by professional reviewers or editors, number of “Likes” or average ratings and number of ratings or other forms of votes or ratings expressed by people using a rating or voting button, opinions expressed by people in social media.

4. The method in claim 3 further comprising displaying a vote or rating button or link near or next to an ad and accepting a positive or negative vote or a star rating on the ad from a user when a user clicks or taps on this button or link.

5. The method in claim 3 further comprising displaying an input box and accept comments or reviews on the ad from a user.

6. The method in claim 3 further comprising using an extension or plug-in to a browser or an app to add a vote or rating icon in a browser's toolbar or an app's setting, clicking or tapping which will accept a vote or rating from the user on the page or website that is linked by the ad and is currently being viewed by the user.

7. The method in claim 6 further comprising accepting comments or reviews on the page or website that is linked by the ad and is currently being viewed by the user.

8. The method in claim 3 further comprising using data mining techniques to analyze the relations, including non-direct relations, of the sources of the first information with the advertiser of an ad using click patterns, accumulated past knowledge and information gathered over the Internet about the advertiser and the sources.

9. The method in claim 3 further comprising using techniques to prevent manipulation of the vote/rating or comments/reviews by users, including Captcha, analysis the IP patterns of the users entering the vote/rating or comments/reviews, and/or requiring a user to log in using an account before he can vote/rate or comment/review an ad.

10. The method in claim 3 further comprising giving higher weight to the rating and/or comments of a user who has established credibility than a user who has not.

11. The method in claim 3 further comprising using the first information as a factor in the calculation of ranking of results in a search results page.
